(19) United States
(12) Patent Application Publication
(10) Pub. No.: US 2026/0170272 A1
(43) Pub. Date: Jun. 18, 2026

(54) SYSTEMS AND METHODS FOR TUNING MULTILINGUAL MACHINE TRANSLATION MODELS

(71) Applicant: Lightcast, Moscow, ID (US)

(72) Inventors: Xiang Li, Moscow, ID (US); Javaid Manzoor, Moscow, ID (US); Marina Pchelina, Moscow, ID (US); Tyson Silver, Moscow, ID (US)

(21) Appl. No.: 18/979,163

(22) Filed: Dec. 12, 2024

(51) Int. Cl. G06F 40/58; G06F 40/51; G06N 3/0985

(52) U.S. Cl. CPC G06F 40/58; G06F 40/51; G06N 3/0985

(57) ABSTRACT

Systems, methods, and devices for fine-tuning multilingual machine translation models to enhance the accuracy and relevance of translations may collect data including non-English text for a machine translation model. The machine translation model is fine-tuned through a series of adjustments to model parameters. Performance evaluations using linguistic feedback and automated models may allow for iterative improvements the model parameters. The machine translation model may be optimized for applications such as job titles and skill classifications across multiple languages, ensuring contextually appropriate and domain-relevant translations.

### TECHNICAL FIELD

The present disclosure relates generally to the field of machine translation and natural language processing, specifically to systems and processes for fine-tuning multilingual machine translation models.

### BACKGROUND

In the current global economy, multilingual communication is a critical component for businesses operating across different countries and regions. Machine translation systems have become essential tools for automating the translation of content, allowing businesses to bridge language barriers. These systems are used in a variety of applications, from translating documents to facilitating communication between users who speak different languages.

Despite the widespread use of machine translation models, current systems face significant challenges when applied to domain-specific data, such as labor market information. Generic machine translation systems, such as Google Translate and other third-party services, are often insufficient for accurately translating specialized terminologies, job titles, and industry-specific language. This is particularly problematic for sectors that rely on precise translations to maintain the integrity and meaning of the original content. For instance, translations of job titles or qualifications may vary greatly depending on cultural nuances and language-specific features, leading to misunderstandings and misclassifications.

Another issue arises from the inability of existing machine translation models to handle language-specific structures and cultural subtleties. This often results in literal translations that fail to convey the intended meaning in the context of the target language. For example, job titles in certain languages may be translated in a way that is technically correct but inappropriate or confusing in the context of a particular industry or region. Additionally, the lack of adequate handling of gender-specific terms and other linguistic variations in non-English languages presents another hurdle in achieving high-quality translations for labor market data.

Furthermore, the large-scale deployment of machine translation systems across multiple languages and regions presents technical challenges related to the computational efficiency of these systems. Ensuring that machine translation models can be fine-tuned and optimized for specific languages while maintaining real-time performance is critical for large-scale applications. Existing solutions for building and maintaining language-specific translation systems for each language are both costly and unsustainable, especially when applied across dozens of countries.

Accordingly, there is a need for improved systems and processes that can fine-tune machine translation models to address these domain-specific and language-specific challenges, particularly in the context of labor market data.

### SUMMARY

Briefly described, and in various aspects, the present disclosure generally relates to systems and processes for fine-tuning multilingual machine translation models to improve the accuracy and relevance of translations, particularly in specialized domains such as labor market data. Aspects of the disclosure may address the limitations of conventional machine translation systems, particularly in handling industry-specific terms and culturally nuanced translations. By fine-tuning models for domain-specific content and employing adaptive pipelines for text cleaning and linguistic corrections, the systems and processes disclosed herein may provide more accurate, reliable, and scalable multilingual translation solutions.

The disclosed systems may determine training data, adjust model parameters based on performance evaluations, and optimize the translation output for specific applications such as job titles and skill classifications across different languages. In one aspect, the disclosed systems may collect and prepare training data comprising non-English text from various sources. The system applies language-specific parameters, including one or more of word length and target-to-source ratio, to filter out noise and improve the quality of the training data. Based on this data, the system may determine a set of first model parameters for a machine translation model. The performance of the machine translation model may be evaluated using a validation dataset, linguistic feedback, and/or large language model (LLM) evaluation.

In another aspect, the disclosed system may optimize machine translation models by adjusting second model parameters based on translation accuracy, cultural fit, and/or the appropriateness of terminology in the target language. The refined models may be used to generate translation outputs, which may be transmitted to external systems, such as one or more data pipelines or an API for classifying job titles into occupation taxonomies.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for a system for fine-tuning multilingual machine translation models;

FIG. 2 illustrates an example of a process for determining training data for a machine translation model;

FIG. 3 illustrates an example of a process for determining first model parameters based on training data;

FIG. 4 illustrates an example of a process for evaluating the performance of a machine translation model.

FIG. 5 illustrates an example of a process for determining second model parameters based on model performance.

FIG. 6 illustrates an example of a process for fine-tuning a machine translation model.

FIG. 7 illustrates an example of a process for transmitting translated information.

FIG. 8 illustrates an example of a process for fine-tuning multilingual machine translation models.

FIG. 9 illustrates a schematic of an example of a computing device used in the fine-tuning and evaluation of multilingual machine translation models.

FIG. 10 illustrates an example diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

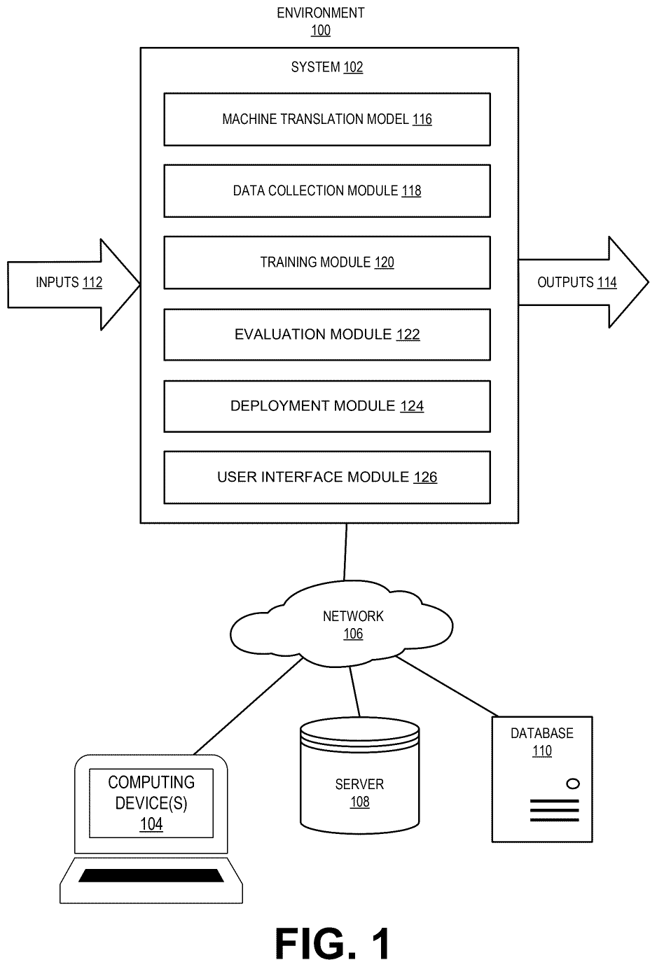

Referring now to the figures, for the purposes of example and explanation of the processes and components of the disclosed systems and methods, reference is made to FIG. 1, which illustrates an environment 100 for a system 102 for fine-tuning multilingual machine translation models to improve translation accuracy in domain-specific contexts such as labor market data. Labor market data may include, but is not limited to titles, skills, and/or occupations. The system 102 may address challenges inherent in translating specialized terminologies, job titles, and industry-specific language across multiple languages. By fine-tuning machine translation models with domain-specific training data and language-specific parameters, the system 102 may enhance translation quality, provide cultural relevance, and increase accuracy. The system 102 may utilize machine learning, natural language processing (NLP), and/or deep learning architectures, including transformer-based models, to enhance the translation of specialized terminologies, job titles, and industry-specific phrases across multiple languages. By utilizing large datasets and language-specific parameters, the system 102 may adapt to the nuances of different languages and cultural contexts, improving both the accuracy and relevance of the translations.

The system 102 may process large volumes of unstructured text efficiently by utilizing a combination of preprocessing techniques and computational optimization strategies. The system 102 may integrate advanced deep learning techniques to enable the translation models to capture complex linguistic patterns and relationships between languages. The capabilities of the system 102 may be further enhanced through use of multi-core processing and GPU acceleration, allowing the system 102 to scale for high-demand applications while maintaining real-time performance in training and translation tasks.

Moreover, the system 102 may handle dynamic updates and continuous improvements. For example, the system 102 may include one or more feedback loops that allow for ongoing refinement of the translation models based on user input and performance evaluations. This adaptive learning approach may ensure that the system 102 remains responsive to changing language trends and evolving domain-specific requirements, making it an ideal solution for applications that require up-to-date and contextually accurate translations. Through these capabilities, the system 102 may address the inherent challenges of multilingual machine translation in specialized fields, providing a robust and scalable solution for businesses operating across different languages and regions.

The system 102 may include a machine translation model 116 configured to translate non-English text into the target language while accounting for domain-specific terminology, linguistic nuances, and/or cultural context. Moreover, the system 102 may include one or more modules to execute various functions in the fine-tuning process. Each module may handle specific aspects, leveraging advanced data processing capabilities to enhance efficiency and accuracy. For example, the system 102 may include one or more of a data collection module 118, a training module 120, an evaluation module 122, a deployment module 124, and/or a user interface module 126.

One or more inputs 112 to the system 102 may include raw non-English text data for training and fine-tuning multilingual machine translation models. The text data may originate from various sources, such as job postings, labor market reports, proprietary datasets, and/or other industry-specific repositories. The inputs 112 may include a wide range of terminologies, job titles, and/or industry-specific phrases for accurately training a machine translation model to handle domain-specific content. The raw non-English text data may vary greatly in terms of language, structure, and content, making it necessary for the system 102 to preprocess and clean the data to ensure consistency and quality across different languages and regions.

According to some aspects, the inputs 112 may include metadata that provides context to the non-English text. The metadata may include information such as the geographic region, industry sector, and/or job function associated with the text. The contextual information may be used to enhance capabilities of the machine translation model 116 ability to handle linguistic and cultural nuances that vary from one language or region to another. For example, a job title in French may be translated differently depending on whether it pertains to a European or Canadian labor market. The system 102 may use the metadata to inform the preprocessing pipeline and ensure that the data is correctly aligned with the target market during model training.

Moreover, the inputs 112 may include language-specific parameters, such as the mean word length, target-to-source ratio, and cultural rules for language processing. The language-specific parameters may be used to tailor the cleaning and preprocessing steps to each language's unique characteristics. For example, job titles in certain languages may use gender-specific terms that need to be normalized before being processed by the translation model. The inputs 112 may also include feedback from human linguists, who may provide corrections or adjustments to ensure that the data is accurately represented in the target language. By incorporating these elements, the system 102 may fine-tune the machine translation model with high-quality, contextually appropriate data.

The machine translation model 116 of system 102 may include a deep learning-based architecture designed to enhance translation quality for domain-specific contexts, particularly in the labor market sector. The machine translation model 116 may leverage one or more transformer-based architectures (e.g., sequence-to-sequence models) to handle complex linguistic patterns across multiple languages. By utilizing pre-trained language models, the machine translation model 116 may efficiently translate non-English text into English while maintaining high accuracy in specialized domains like job titles, technical terms, and/or industry-specific language. While the disclosure discusses non-English and English texts for exemplary purposes, in some embodiments the machine translation model 116 may efficiently translate from one or more language texts into a particular language text, while maintaining high accuracy in specialized domains as will be understood by those skilled in the art.

According to some aspects, the machine translation model 116 may include a fine-tuning process for incorporation of language-specific parameters (e.g., mean word length and/or target-to-source ratio). The language specific parameters may be derived through empirical analysis of language data and linguistic research. Based on the language specific parameters, the machine translation model 116 may filter out noisy data and focus on meaningful input. For example, job titles with abnormally long or short translations, as indicated by deviations in the target-to-source ratio, may be flagged and either corrected or excluded from the training data. This filtering may improve the overall quality and relevance of the translations.

According to some aspects, the machine translation model 116 may be optimized by integrating feedback from domain experts and linguistic teams. For instance, human linguists may validate the translated output (e.g., outputs 114), providing annotations on cultural fit and terminology appropriateness. This feedback loop may further enhance the capabilities of the machine translation model 116 to handle industry-specific language and cultural nuances, reducing the likelihood of literal or incorrect translations. As a result, the machine translation model 116 may deliver accurate translations and align the translated output (e.g., outputs 114) with local industry standards.

Moreover, the machine translation model 116 may employ an adaptive text cleaning pipeline, which may preprocess raw non-English text data before feeding it into the model. The pre-processing pipeline may remove noise, such as emojis and non-alphanumeric sequences, and apply language-specific post-processing rules to handle unique grammatical or cultural features. For example, in languages like Korean, titles containing respectful honorifics may be preprocessed to remove redundant terms that do not contribute to the translation. The adaptive text-cleaning pipeline may allow the machine translation model 116 to focus on the core meaning of the text.

According to some aspects, the machine translation model 116 may support real-time translation capabilities, utilizing multi-core processing and GPU acceleration to maintain high-performance levels in large-scale applications. The use of multi-core proceeding and GPU acceleration may allow the machine translation model 116 to process vast amounts of data and produce translations efficiently, making the machine translation model 116 suitable for deployment in global operations where translation accuracy and speed are critical.

The data collection module 118 of the system 102 may gather and preprocess large volumes of raw non-English text data (e.g., inputs 112), which may be used to fine-tune the machine translation model 116. The data collection module 118 may apply an adaptive text cleaning pipeline to remove noise from the raw data and provide high-quality inputs for model training. For instance, noise such as emojis, non-alphanumeric sequences, and other irrelevant content may be identified and removed to prevent it from negatively affecting the accuracy of the machine translation. The preprocessing may improve the performance of the machine translation model 116, particularly when dealing with specialized labor market data across different languages.

According to some aspects, the adaptive text cleaning pipeline implemented by the data collection module 118 may apply rule-based language-specific post-processing to handle cultural and linguistic nuances. For example, the adaptive text cleaning pipeline may identify and remove repetitive patterns such as sequences of special characters (e.g., “!!!” or “###”), while preserving important language-specific characters that are integral to the meaning of the text (e.g., “C++” in programming titles). Moreover, the adaptive text cleaning pipeline may implement language-specific rules, such as adjusting for the presence of gender-specific terms in languages such as French and Spanish, which may require normalization before being fed into the machine translation model 116.

The data collection module 118 may use language-specific parameters (e.g., mean word length and target-to-source ratio) to refine the training data by filtering out short titles and anomalous translations. The language-specific parameters may be derived from empirical research on different languages and may help eliminate noisy or irrelevant data. For example, if the mean word length for valid job titles in a particular language is determined to be five words, the data collection module 118 may discard any entries significantly shorter than the mean-word length threshold (e.g., five words), as these are likely to be incomplete or erroneous job titles. The target-to-source ratio may be used to filter out cases where the translated string length differs disproportionately from the source string, indicating potential translation errors.

According to some aspects, the data collection module 118 may integrate multiple data sources to enhance the diversity and quality of the training data. The multiple data sources may include publicly available job postings, proprietary labor market databases, and/or previously translated datasets. By consolidating data from various sources, the data collection module 118 may facilitate training the machine translation model 116 on a wide range of real-world job titles, increasing its ability to generate accurate and contextually relevant translations across different industries and regions.

According to some aspects, the data collection module 118 may leverage multi-core processing techniques to handle large-scale data collection and processing. For example, by utilizing must-core processing, the system 102 may manage large volumes of text data in parallel, providing timely data preparation for training of the machine translation model 116. By maintaining input-output alignment during the cleaning and preprocessing steps, the data collection module 118 may provide consistent and reliable processed data for the subsequent stages of training the machine translation model 116.

The training module 120 of the system 102 may prepare the training datasets and fine-tune the machine translation model 116. According to some aspects, the training module 120 may begin by processing the cleaned and filtered data from the data collection module 118. This data may include labor market-specific and/or non-English text that has undergone noise removal and language-specific filtering, such as emoji removal and the handling of non-alphanumeric sequences. The training module 120 may apply one or more additional preprocessing steps as needed, such as ensuring consistent capitalization and punctuation, to maintain the quality and relevance of the training data.

The training module 120 may determine the first model parameters based on this processed training data, adjusting hyperparameters such as learning rates, dropout rates, and/or batch sizes. The hyperparameters may be used to optimize the performance of the machine translation model 116 by ensuring that it converges toward an optimal solution without overfitting the data. For example, the training module 120 may adjust the learning rate dynamically based on performance of the machine translation model 116 on the validation set, enabling faster convergence in early stages while fine-tuning adjustments during later iterations to avoid overshooting the optimal solution.

The training module 120 may utilize one or more transformer-based architectures, such as sequence-to-sequence models. The transformer-based architectures may allow the machine translation model 116 to understand the contextual relationships between words across different languages, maintaining semantic accuracy in the translations even in domain-specific content like job titles. The system 102 may incorporate pre-trained models and fine-tune them using labor market-specific training data to improve the translation of specialized terminologies that might not be well-represented in generic translation models. For example, the training module 120 may fine-tune the machine translation model 116 to distinguish between job titles such as “cloud engineer” and the literal translation of the term “engineer of clouds.”

According to some aspects, the training module 120 may incorporate a feedback loop with domain experts and linguists to improve translation quality. The experts may provide annotations on cultural fit and terminology appropriateness. The training module 120 may use the provided feedback to refine the training dataset. For example, if a literal translation is flagged as culturally inappropriate or unclear, the training module 120 may adjust the training data and parameters for the machine translation model 116 to produce accurate and culturally relevant translations. The iterative feedback process may enable the system 102 to continuously improve its translation quality for domain-specific contexts.

Moreover, the training module 120 may utilize multi-core processing and GPU acceleration to handle the large-scale computational tasks associated with fine-tuning the machine translation model 116. These multi-core processing and GPU acceleration may allow the system 102 to efficiently process large volumes of labor market data (e.g., job titles, skills, occupations, etc.), improving the ability of the system 102 to deliver translations at scale without sacrificing accuracy. This scalability may be beneficial for global applications, where real-time translation and model updates are required to support a wide range of languages and regions.

The evaluation module 122 of the system 102 may assess the performance of the fine-tuned machine translation model 116. According to some aspects, the evaluation module 122 may leverage multiple a plurality of evaluation techniques to enable the machine translation model 116 to produce translations with high accuracy and relevance, especially in the context of labor market data (e.g., job titles, skills, occupations, etc.). The evaluation module 122 may assess performance of the machine translation model 116 using validation datasets comprising domain-specific content, including one or more of job titles, skills, or industry-specific terminologies. The evaluation module 122 may provide a systematic way to quantify the translation accuracy of the machine translation model 116, enabling continuous improvement and ensuring the machine translation model 116 meets the desired performance thresholds before deployment.

According to some aspects, evaluation metrics employed by the evaluation module 122 may include translation accuracy. The translation accuracy may be determined by comparing output from the machine translation model to one or more ground truth translations in a validation dataset. The validation dataset may include one or more common and/or rare job titles across multiple languages, such that the machine translation model 116 is tested on a representative sample of data. Additionally, cultural fit and terminology appropriateness may be evaluated by incorporating linguistic feedback. Domain experts and linguists may review translations to verify that the output is not only linguistically correct but also contextually appropriate for the target industry, thus ensuring that job titles are translated in a way that resonates with local industry practices.

The evaluation module 122 may utilize large language models (LLMs) as part of the evaluation process. For example, advanced LLMs (e.g., GPT-4o), may be prompted to review and assess alignment between the predicted translations and the associated occupational taxonomy classifications. This automated evaluation may be used to detect inconsistencies between the translated text and its intended classification, allowing for a scalable evaluation process. The LLM-based assessment may provide a mechanism to further refine the machine translation model 116 by identifying areas where the machine translation model 116 might produce literal translations that lack cultural nuance or precision.

According to some aspects, the evaluation module 122 may integrate performance metrics such as target-to-source ratio and word-length consistency. The performance metrics may be used to identify anomalies in translations, such as excessively long or short translations relative to the source text, which may indicate potential errors in the translation process. By leveraging these quantitative metrics alongside expert feedback, the evaluation module 122 may provide a comprehensive evaluation of the performance of the machine translation model 116, covering both technical and cultural aspects of translation.

The evaluation module 122 may provide continuous improvement through an iterative feedback loop. Feedback from linguists and the results of LLM-based evaluations may be incorporated back into the training pipeline of the machine translation model 116, enabling the system 102 to fine-tune its parameters and improve its translation quality over time. This approach may ensure that the machine translation model 116 remains responsive to evolving language trends and domain-specific needs, delivering high-quality translations that meet the specific demands of labor market data (e.g., job titles, skills, occupations, etc.).

The deployment module 124 of the system 102 may integrate the fine-tuned machine translation model 116 into production environments. This deployment module 124 may facilitate transmission of translated information to external systems (e.g., via data pipelines) or APIs, which may be essential for client-facing services like the classification of job titles into occupational taxonomies. By ensuring that the outputs (e.g., outputs 114) of the machine translation model 116 are accessible to external platforms, the deployment module 124 may enable real-time translation and classification tasks, e.g., for businesses that require seamless multilingual operations across different regions and industries.

According to some aspects, the deployment module 124 may connect the fine-tuned machine translation model 116 to one or more client-facing systems, such as occupation taxonomy classification APIs. For example, a translated job title from German may be sent to an API that classifies it into an occupation taxonomy associated with a job search platform, correctly aligning the job title with the target industry and cultural context. This real-time integration may allow businesses to automate their classification processes across multiple languages without needing a separate occupation classifier for each language. Moreover, the deployment module 124 may connect the machine translation model 116 to one or more data pipelines, e.g., a series of automated processes that move data from its source to a destination. The one or more data pipelines may include one or more steps, such as extraction, transformation, and loading (ETL) to prepare data for analysis or further use.

Moreover, the deployment module 124 may provide a solution to the problem of scaling machine translation and classification systems globally. The deployment module 124 may reduce the need for developing and maintaining language-specific systems by providing a universal interface through which translations may be transmitted and used. The deployment module 124 may handle the complexities of communication between the system 102 and external platforms, ensuring that translated information is efficiently classified and utilized within the client's ecosystem. For instance, the deployment module 124 may optimize data transmission by managing payload sizes and formats based on the API specifications of different client systems.

To further enhance performance, the deployment module 124 may leverage load balancing and multi-threading techniques to manage large-scale translation requests. The load balancing and multi-threading techniques may allow the system 102 to maintain high throughput and low latency, even when dealing with large volumes of data across different languages. The deployment module 124 may also include error-handling mechanisms to address potential issues such as API failures or discrepancies between the source and target languages during classification.

According to some aspects, the deployment module 124 may provide continuous delivery of translated data by supporting updates to the machine translation model 116 without downtime. The fine-tuned machine translation model 116 may be retrained and redeployed in response to feedback from the evaluation module 122, ensuring that the latest model enhancements are quickly propagated to production environments. Thereby, the deployment module 124 may maintain adaptability of the system 102 and relevance in changing language and industry landscapes.

The user interface module 126 of system 102 may provide an interactive platform that enables users to engage with various stages of the fine-tuning process of the machine translation model 116. Users may interact with one or more components associated with the machine translation model 116 (e.g., model configurations, training datasets, and/or evaluation metrics), enhancing transparency and control over the machine translation process. Features of the user interface module 126 may include inputting language-specific parameters such as the mean word length and target-to-source ratio. By enabling users to set these parameters, the system 102 may better adapt to language nuances, filtering out noisy data and improving translation accuracy.

According to some aspects, the user interface module 126 may provide real-time monitoring of the training process. Users may track progress through graphical representations of training data performance, validation metrics, and/or real-time feedback loops. The user interface module 126 may display visualizations such as loss curves, accuracy graphs, and other key performance indicators (KPIs) that reflect the ability of the machine translation model 116 to adapt to the training data. For example, users may observe how adjustments to hyperparameters, such as learning rates or batch size, affect the performance of the machine translation model 116 over time, providing insights into optimization strategies.

Moreover, the user interface module 126 may facilitate user-driven evaluations of the fine-tuned machine translation model 116. For example, after the fine-tuning process is completed, the user may access linguistic evaluations and feedback collected from domain experts. This feedback may be integrated into the user interface, allowing users to see which translations were flagged as incorrect or requiring cultural adjustment. The real-time feedback may allow users to further refine the machine translation model 116 by retraining the machine translation model 116 based on specific linguistic insights, improving overall translation quality for domain-specific content.

According to some aspects, the user interface module 126 may include deployment management capabilities. Once the machine translation model 116 is fine-tuned and evaluated, users may control how the machine translation model 116 is deployed into production environments through the user interface. For example, the user may schedule model deployments, manage integration with external APIs, and/or set up real-time data flows between the machine translation model 116 and client-facing systems, such as occupation taxonomy classifiers. Thereby the translation outputs may be efficiently used by external platforms for classification or other multilingual services.

Moreover, the user interface module 126 may present detailed data visualization tools to interpret the performance of the machine translation model 116 in real-time production environments. Users may analyze metrics such as translation accuracy, response times, and system throughput. In high-demand applications, the system 102 may display load-balancing and resource utilization metrics, enabling users to optimize the deployment further by managing computational resources like GPU utilization. The data visualization tools may provide a holistic view of the operation of the system 102 and facilitate the fine-tuning of deployment strategies for large-scale applications across multiple languages.

The outputs 114 of the system 102 may include translation results generated by the fine-tuned multilingual machine translation model 116. The outputs 114 may include one or more of translated job titles, skill descriptions, and/or other labor market data, which may be tailored for specific domains, such as labor market information (e.g., job titles, skills, occupations, etc.), by incorporating domain-specific and language-specific parameters during the translation process. For example, the system 102 may translate a job title from German into English, ensuring that culturally nuanced terms, such as “Cloud Engineer,” are translated accurately in context rather than literally (e.g., avoiding “engineer of clouds”). The outputs 114 may be subsequently used by external systems, such as APIs, for classifying translated job titles into an occupation taxonomy, such as an occupation taxonomy associated with an employment search. The system 102 may ensure that the outputs 114, including translated data, is categorized appropriately for downstream applications, providing a technical solution to the problem of accurately translating and classifying job titles across multiple languages and regions.

Connected to the system 102 may be one or more computing devices 104, each of which may vary widely in their design and application but sharing a common capability to process and analyze data. The computing device(s) 104 may be configured to communicate data, settings, or results (e.g., fine-tuned multilingual machine translation results) between (e.g., to or from) the system 102 and external systems or applications. The computing devices 104 may include processors and memory capable of handling large-scale processing tasks, such as executing translation jobs for labor market data and ensuring the results, such as job titles or skill descriptions, are accurately transmitted or presented to users (e.g., via a user interface). Moreover, the computing devices 104 may manage the interface between the machine translation model and client-facing APIs, ensuring that the output of translated job titles is classified into occupation taxonomies and enhancing the usability of the data. According to some aspects, the computing device(s) 104 may provide scalability and real-time performance of the system 102 by leveraging multi-core processing and GPU acceleration for high-throughput translation tasks. The one or more computing devices 104 may be interconnected via a network 106, enabling the sharing and transmission of data and results throughout the environment 100. Network 106 may encompass a variety of networking technologies to facilitate the seamless flow of information and ensure the robust operation of the system 102.

According to some aspects, a server 108 may function as a central processing unit. The server 108 may house, manage, and/or coordinate the system 102, including the overall machine translation and fine-tuning process. For example, the server 108 may handle requests from external systems, process translation tasks, and/or integrate feedback for retraining the machine translation model 116 based on linguistic input or LLM evaluation. Moreover, the server 108 may manage the interaction with the database 110 for storing and retrieving training and evaluation data. For example, the server 108 may receive non-English job titles, apply fine-tuned machine translation models, and send the translated results to one or more external systems. Moreover, the server 108 may use techniques such as GPU acceleration and batch processing optimization to maintain high efficiency and ensure the system 102 is capable of real-time translation at scale.

The database 110 may store various forms of data associated with the fine-tuning and translation processes, including raw non-English text data, processed training datasets, evaluation results, and/or linguistic feedback. According to some aspects, the database 110 may provide the data for training the machine translation model 116 and/or housing large datasets from sources such as job postings or proprietary labor market databases. Moreover, the database 110 may support the adaptive text cleaning pipeline, which may filter and preprocess data to remove noise such as emojis and non-alphanumeric sequences. The database 110 store one or more iterations of training data and model parameters, providing accessibility for retraining cycles. For example, the database 110 may hold job title translations and linguistic annotations that may be used to refine and fine-tune the machine translation model 116 over time, providing a repository of high-quality, domain-specific data for continual model improvement.

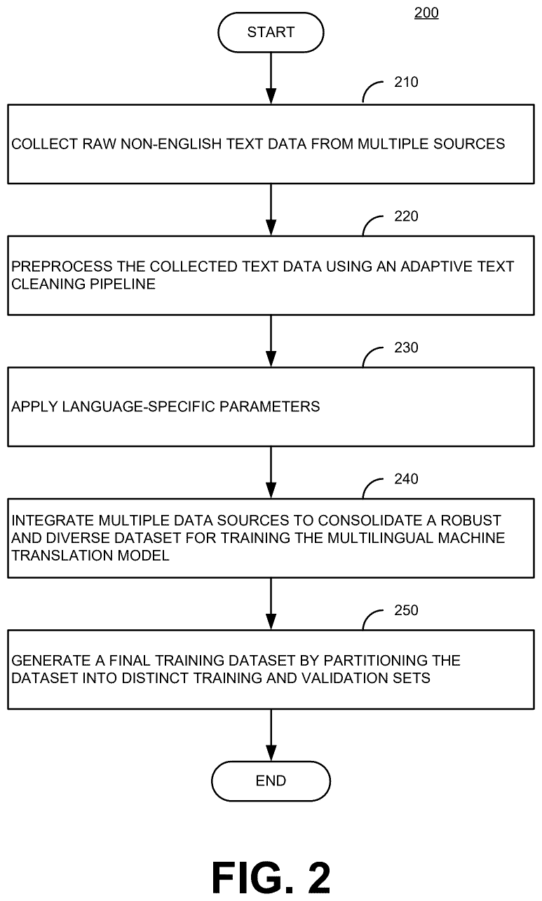

FIG. 2 illustrates an example of a process 200 for determining training data for a machine translation model. The training data may lay the groundwork for creating a machine translation model that provides accurate, culturally relevant translations, particularly for domain-specific applications like classifying job titles or skills across different languages and regions. This process 200 may provide a technical solution by improving the accuracy and cultural relevance of translations, addressing issues such as literal translations or mistranslations of domain-specific terminology.

At step 210, the process 200 may collect raw non-English text data from multiple sources, such as job postings, labor market reports, and proprietary datasets. The sources may be selected based on their relevance to the domain-specific content, such as labor market data (e.g., job titles, skills, occupations, etc.). For example, job postings and labor market reports often contain specialized terminologies, industry-specific phrases, and/or localized expressions that differ across regions and languages. The raw text data may encompass a wide range of languages and domains, making it suitable for training a multilingual machine translation model that requires adaptation to various industries, such as information technology, healthcare, or manufacturing. The collected data may provide the foundation to develop training sets that allow the machine translation model to handle nuanced translations of specific terms, job titles, and skills.

The data collected at step 210 may cover a broad spectrum of linguistic and industry-specific variations to enhance the capability of the machine translation model to address real-world scenarios. For example, job titles such as “Cloud Engineer” may appear differently in different languages, or certain terms may have culturally specific meanings that require specialized translation handling. By pulling from proprietary datasets and publicly available resources, the process 200 may capture the most relevant and up-to-date terms and phrases. Additionally, by incorporating metadata, such as industry sector, geographic region, and/or job function, the process 200 may contextualize the raw text data to ensure that the resulting translations align with industry standards and local labor market practices.

At step 220, the process 200, may preprocess the collected text data using an adaptive text cleaning pipeline to remove noise and improve the quality of the training data. The preprocessing may enhance the performance and accuracy of the machine translation model by eliminating irrelevant or misleading content, such as emojis, non-alphanumeric sequences, and/or excessive punctuation. The irrelevant or misleading content may interfere with the ability of the machine translation model to accurately learn the structure and meaning of the text, particularly in domain-specific contexts such as labor market data. For example, job postings often contain extraneous symbols or emoticons, such as “!!!” or “:),” that do not contribute to the translation of specialized terms or industry-specific phrases. By systematically filtering out such noise, the text cleaning pipeline may provide data to the machine translation model that is clean, consistent, and relevant, which may improve the quality and reliability of the resulting translations.

Moreover, step 220 may include application of language-specific post-processing rules tailored to the linguistic characteristics of the target languages. The adaptive aspect of the text cleaning pipeline may allow the system to handle unique grammatical structures, cultural nuances, and/or other linguistic variations that may differ significantly across languages. For example, in Korean, job titles may include respectful honorifics that may not be relevant to the core meaning of the job title in other languages. The text cleaning pipeline may be configured to strip the honorifics and focus on key elements of the job title, providing accurate and contextually appropriate job titles. Similarly, the process 200 may normalize gender-specific terms in languages like French or Spanish, where grammatical gender may play a significant role in word formation. The post-processing rules may allow the process 200 to fine-tune the data for each language, thereby enabling the machine translation model to produce translations that are accurate, culturally relevant, and contextually relevant across different languages and regions.

At step 230, the process 200 may apply language-specific parameters, such as mean word length and target-to-source ratio, to refine the training data by filtering out anomalous or noisy entries. The language-specific parameters may ensure the quality and consistency of the data used to train the machine translation model. The mean word length parameter may be used to detect job titles or industry-specific phrases that deviate significantly from the expected word count for a given language. For example, if the average word length for job titles in a particular language is five words, any data point with an unusually short or long word count may indicate that the translation is either incomplete or overly literal. The process 200 may flag such entries for review, and depending on the severity of the deviation, the entries may either be excluded from the dataset or corrected to maintain the integrity of the training data. Thereby the process 200 may help the machine translation model avoid overfitting on irregular data and improves its ability to generalize across a wide range of translation tasks.

The target-to-source ratio parameter may be associated with assessing proportionality between the length of the source text and its corresponding translation. According to some aspects, the target-to-source ratio may be used to identify translations that are either excessively long or short relative to the original text, which may be a sign of mistranslation. For example, a job title translated from English to German may have a disproportionately long target string due to the compound nature of German words. If the translated string is excessively long, the system may flag the translation as potentially erroneous. The filtering applied by the process 200 may reduce the presence of noisy or misleading data and enhance the ability of the machine translation model to learn accurate and culturally relevant translations, ultimately leading to more reliable outputs in production environments.

At step 240, the process 200 may integrate multiple data sources to consolidate a robust and diverse dataset for training the multilingual machine translation model. The integration may include combining data from various origins, such as proprietary labor market databases, publicly available job postings, industry reports, and/or other relevant sources of domain-specific content. By merging these sources, the process 200 may provide a comprehensive and contextually relevant training dataset, enhancing the model's ability to generate accurate translations across multiple languages and industries. Proprietary labor market data, for example, may include specialized job titles, skills, and/or qualifications not commonly found in public datasets, while publicly available data may add breadth by capturing more generalized job titles and terminologies.

This consolidation of data from diverse sources may address a key technical challenge in machine translation, such as the lack of domain-specific examples in publicly available datasets. For example, proprietary labor market databases may include highly specialized job titles such as “Nanomaterials Engineer” or “Machine Learning Scientist,” which may be essential for ensuring the model accurately translates industry-specific terms. Publicly available job postings, on the other hand, may provide more common job titles such as “Software Developer” or “Project Manager,” ensuring the model is well-rounded and performs well in both general and niche applications. By integrating the data sources, step 240 may provide a refined dataset that captures the full spectrum of job titles and industry phrases, making the training data both rich in domain-specific knowledge and broad enough to handle a wide variety of translation tasks. Moreover, integrating the data sources may ensure that the machine translation model can learn from high-quality, diverse examples, ultimately improving its ability to handle multilingual translations in real-world labor market applications.

At step 250, the process 200 may generates the final training dataset by partitioning the refined dataset into distinct training and validation sets, ensuring that the machine translation model receives balanced data for learning and performance evaluation. According to some aspects, a portion of the dataset (e.g., around 90%) may be allocated to the training set, while the remainder may be reserved for validation. Partitioning the refined dataset may ensure that the machine translation model has access to sufficient data to learn from, while also providing an independent set of data for performance evaluation during the validation phase. The training set may include diverse examples of job titles, industry-specific terms, and linguistic nuances across various languages, allowing the machine translation model to develop a deep understanding of domain-specific content during the training process.

The validation set (e.g., representing around 10% of the data), may serve as a benchmark to measure the translation accuracy and generalization capabilities of the machine translation model. For example, if the machine translation model is trained on a job title such as “Data Scientist” in multiple languages, the validation set may include similar titles such as “Machine Learning Engineer” or “AI Specialist” to test how well the machine translation model performs on related terms. By keeping the validation data separate from the training data, the process 200 may effectively evaluate whether the fine-tuning process is leading to improvements in translation quality, especially for labor market data, without overfitting to the training examples. This process 200 may allow for adjustments to model hyperparameters, such as learning rates and dropout rates, ensuring that the final model is optimized for high-quality, contextually relevant translations, improving performance across real-world labor market scenarios.

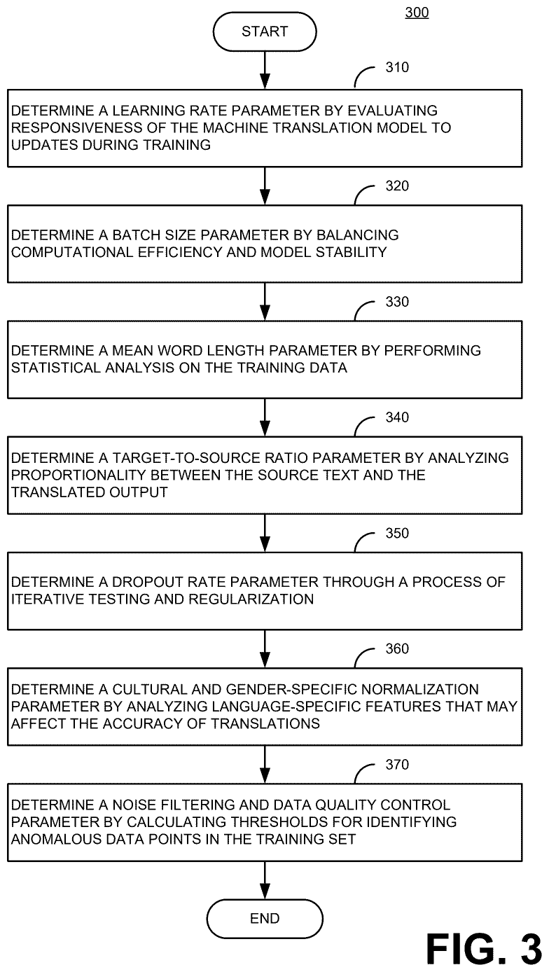

As illustrated in FIG. 3, process 300 may determine one or more first model parameters based on a training dataset (e.g., a dataset received from process 200). Process 300 may include one or more of step 310, step 320, step 330, step 340, step 350, step 360, and/or step 370, and the respective steps may be performed in any particular order.

At step 310, a learning rate parameter may be determined by evaluating responsiveness of the machine translation model to updates during training. According to some aspects, a baseline learning rate may be selected based on prior models or empirical studies. As the training progresses, the learning rate may be dynamically adjusted using one or more gradient descent algorithms. Early in the process, the rate may be increased to allow rapid changes in model weights for faster convergence. The rate may be calculated based on performance metrics like loss reduction. As training continues, the learning rate may be gradually reduced. For example, learning rate scheduling and/or adaptive learning rate methods may be used to monitor the rate of convergence and decrease the learning rate to avoid overshooting an optimal model configuration. For example, if the loss function plateau indicates diminishing returns, the learning rate may be reduced to fine-tune the machine translation model and achieve higher accuracy.

At step 320, a batch size parameter may be determined by balancing computational efficiency and model stability. An optimal batch size may be calculated based on hardware constraints (e.g., GPU memory), size of the dataset, and/or variance in gradient estimates. For example, larger batch sizes may be initially chosen to maximize computational throughput and minimize training time. If gradient updates are determined to be too noisy or unstable (e.g., as indicated by fluctuations in loss metrics), the batch size may be dynamically reduced. Adjustment of the batch size parameter may be guided by one or more of empirical testing, monitoring the variance of gradient updates, and/or using batch normalization techniques to calculate the most effective batch size for a stable training process while maintaining computational efficiency.

At step 330, a mean word length parameter may be determined by performing statistical analysis on the training data. For each language in the training set, the average word length may be computed by analyzing a large corpus of domain-specific text (e.g., job titles). For example, the total number of words and the total number of characters in the dataset may be calculated, and then total number of characters may be divided by the total number of words. Words or sequences that significantly deviate from the computed mean word length, such as abnormally long or short job titles, may be identified as potential noise. The potentially noisy entries may be filtered out to improve the overall quality of the training data. The mean word length parameter may be empirically validated by comparing the results of translations using different thresholds to determine the optimal mean word length for the given language and domain.

At step 340, a target-to-source ratio parameter may be determined by analyzing proportionality between the source text and the translated output. For example, the target-to-source ratio may be determined by dividing the length (e.g., in characters or tokens) of the translated text by the length of the original source text. A baseline ratio may be established for each language pair based on prior translations or linguistic research. Deviations from the baseline, such as excessively long or short translations relative to the source, may be flagged as potential mistranslations. The target-to-source ratio may be fine-tuned by analyzing how different ratios correlate with translation quality. According to some aspects, the target-to-source ratio may be adjusted based on feedback from human linguists or automated evaluation systems to ensure that the translated text maintains an appropriate scale relative to the original.

At step 350, a dropout rate parameter may be determined through a process of iterative testing and regularization. For example, a baseline dropout rate (e.g., such as around 0.5) may be determined, where a percentage (e.g., associated with the baseline dropout rate, such as around 50%) of the neurons in a neural network layer may be randomly deactivated during each training iteration. The performance of the machine translation model on a validation dataset may be monitored, and overfitting tendencies may be calculated by observing the difference between training and validation accuracy. If overfitting is detected (e.g., indicated by significantly better performance on training data than on validation data), the dropout rate may be increased. Conversely, if underfitting is detected (e.g., where the model is too simple), the dropout rate may be reduced. This balance may be calculated iteratively so that the machine translation model learns generalized patterns from the data without relying too heavily on specific training examples.

At step 360, a cultural and gender-specific normalization parameter may be determined by analyzing language-specific features that may affect the accuracy of translations. For example, gendered terms in languages like French and Spanish may be detected using linguistic rules or pre-defined dictionaries that identify such terms. The gendered terms may be normalized to provide culturally appropriate translations by applying gender-neutral or culturally specific alternatives. The cultural and gender-specific normalization parameter may be adjusted based on empirical feedback from linguistic experts and automated translation tests. The adjustment of the cultural and gender-specific normalization parameter may respect cultural and gender-specific nuances without losing their meaning or appropriateness in the target language.

At step 370, a noise filtering and data quality control parameter may be determined by calculating thresholds for identifying anomalous data points in the training set. Statistical analysis may be performed on the dataset, calculating metrics such as the mean and standard deviation of job title lengths, term frequencies, and punctuation patterns. Entries that fall outside of a pre-determined range (e.g., two standard deviations from the mean) may be classified as noise and excluded from the training process. The thresholds may be refined by testing different filtering criteria and evaluating the translation accuracy of the resulting machine translation model. Thereby the noise filtering and data quality control parameter may ensure that the machine translation model is trained on high-quality data and that noisy, irrelevant, or inconsistent entries are effectively filtered out.

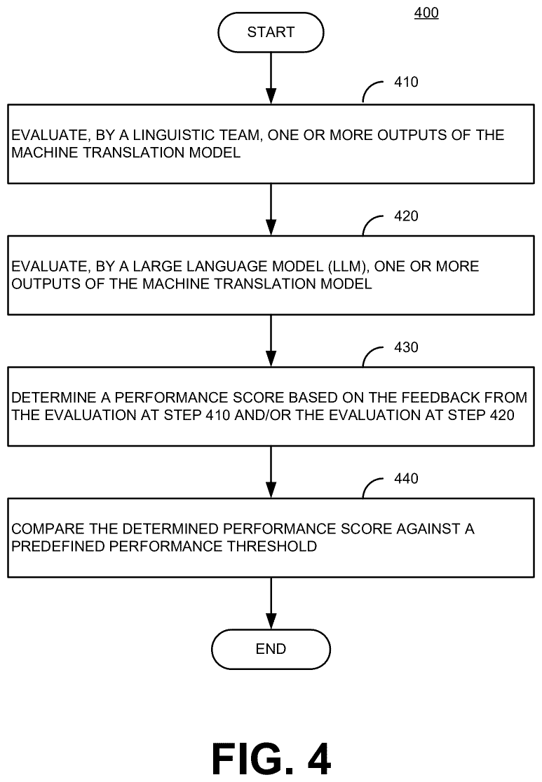

As illustrated in FIG. 4, process 400 may evaluate the performance of a machine translation model to improve translations for labor market data (e.g., job titles, skills, occupations, etc.). Process 400 may include one or more of step 410, step 420, step 430, and/or step 440, and the respective steps may be performed in any particular order.

At step 410, one or more outputs of the machine translation model may undergo human evaluation, specifically by a linguistic team. For example, the linguistic team may review and categorize translations based on criteria such as accuracy, cultural fit, and/or contextual relevance. This detailed assessment may include analyzing each translated output and assigning one of several classifications, such as “correct,” “incorrect,” or “could be improved.” For example, a translation may be grammatically correct but contextually inappropriate, requiring adjustment for cultural nuances. The linguistic team may provide granular feedback, such as pointing out where literal translations fall short in capturing the intended meaning in a specific domain, such as translating job titles between languages with varying terminologies.

According to some aspects, step 410 may provide an iterative feedback loop that enhances the ability of the machine translation model to adapt to industry-specific terminology and cultural subtleties. The human feedback may be integrated into the machine learning process, enabling the machine translation model to correct its translation patterns and improve over time. For instance, if the machine translation model translates a job title such as “Cloud Engineer” into a literal translation of “Engineer of Clouds,” human reviewers may guide the model towards interpreting “cloud” in the context of technology, not meteorology. The ongoing interaction between human expertise and machine learning may allow for continuous refinement and alight the machine translation model aligns with domain-specific requirements.

At step 420, one or more outputs of the machine translation model may undergo automated evaluation, e.g., by an advanced large language model (LLM), such as GPT-4o. Step 420 may provide an automated, scalable evaluation mechanism that can process large volumes of translated text. The LLM may be prompted to assess whether the predicted translations align with the relevant occupational taxonomy or meet the structural and contextual needs of a specific industry. According to some aspects, appropriateness in relation to job titles and descriptions may be cross-checked against one or more predetermined taxonomies.

Moreover, the LLM evaluation may complement human review by addressing the challenge of scaling translation assessments. While human reviewers may focus on detailed linguistic feedback, the LLM may quickly analyze large datasets, identifying structural mismatches, linguistic anomalies, and context misalignment. For example, the LLM may flag instances where a translated job title significantly deviates from expected length parameters (e.g., mean word length or target-to-source ratio), which may indicate a mistranslation or unnecessary verbosity. This automated approach may support real-time translation refinement, particularly in large-scale applications involving vast quantities of labor market data (e.g., job titles, skills, occupations, etc.) across multiple languages.

At step 430, a performance score may be determined based on the feedback from the linguistic evaluation at step 410 and/or the LLM assessment at step 420. The performance score may include a quantifiable metric that reflects the accuracy, cultural relevance, and/or overall quality of the outputs of the machine translation model. The performance score may be derived from one or more factors, such as translation accuracy, contextual appropriateness, and/or adherence to domain-specific terminology. The factors may be aggregated to generate a numerical or categorical score, which may serve as an indicator of the reliability of the machine translation model in producing accurate translations.

According to some aspects, the performance score calculation may include weighting the input from different evaluation methods. For instance, feedback from the linguistic team may carry more weight in terms of cultural fit, while the analysis from the LLM may provide a broader metric for structural alignment across large datasets. The ability of the machine translation model to adapt to feedback from both sources may ensure that the performance score is a comprehensive measure of its capabilities. For example, a low performance score may indicate the need for retraining the machine translation model on specific job titles or industry-specific phrases, while a high score may suggest that the machine translation model is successfully generalizing its translations across different languages and contexts.

At step 440, the process 400 may compare the determined performance score against a predefined performance threshold. This comparison may be used to determine whether the performance of the machine translation model is adequate for deployment or if further refinement is required. The performance threshold may be set based on business or industry requirements and may quantify that the machine translation model meets a minimum standard before being used in production environments. For example, in translating job titles, the threshold may be based on how well the model handles specific terminologies and cultural variations relevant to labor market data (e.g., job titles, skills, occupations, etc.).

Setting and/or comparing the performance threshold may include monitoring key performance indicators (KPIs) such as translation accuracy and cultural appropriateness. If the performance score falls below the performance threshold, a retraining cycle may be triggered to adjust] model parameters or incorporate additional training data to improve translation quality. According to some aspects, the retraining may focus on specific areas where the machine translation model underperforms, such as handling gender-specific terms or culturally sensitive job titles. Moreover, the performance threshold may serve as a benchmark for ensuring that only high-quality translations are used in real-world applications.

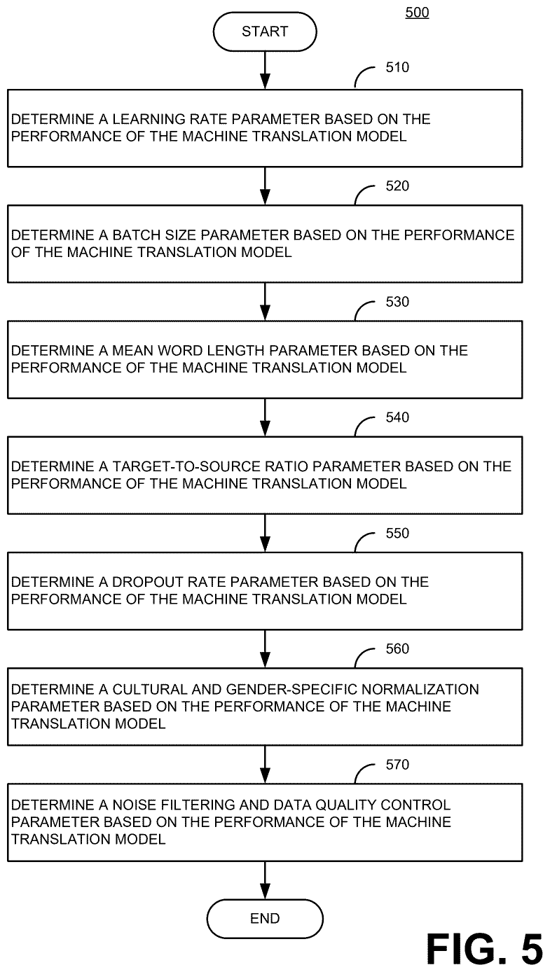

As illustrated in FIG. 5, process 500 may determine second model parameters based on the performance of a machine translation model (e.g., as determined by process 400). According to some aspects, one or more of the steps of the process 500 may be performed by generalizing translations by a deep learning model.

At step 510, the process 500 may determine a learning rate parameter based on the performance of the machine translation model (e.g., as determined by process 400). For example, the learning rate parameter may be determined based on the responsiveness of the machine translation model to updates during training. The learning rate may govern how quickly the machine translation model may adjust its weights in response to new data. Initially, a baseline learning rate may be set. The leaning rate may be adjusted dynamically based on performance metrics such as loss reduction. During early training stages, the learning rate may be increased to accelerate convergence. As the machine translation model nears optimal performance, the learning rate may be gradually reduced to avoid overshooting and fine-tune translation accuracy. For example, if the loss function plateaus, the learning rate may be decreased to ensure more precise adjustments.

At step 520, the process 500 may determine a batch size parameter based on the performance of the machine translation model (e.g., as determined by process 400). For example, the batch size parameter may be determined by calculating an optimal trade-off between computational efficiency and model stability. Batch size may refer to the number of training examples processed in a single iteration. A larger batch size may be selected to maximize computational throughput, but this may cause noisy gradient updates. Smaller batch sizes may provide more stable gradient updates but slow the training process. By evaluating the variance in gradient updates and monitoring loss fluctuations, the batch size may be dynamically adjusted to provide both stability and efficient training.

At step 530, the process 500 may determine the mean word length based on the performance of the machine translation model (e.g., as determined by process 400). For example, the process 500 may calculate the mean word length parameter through statistical analysis of the training data. The average word length for each language may be determined by dividing the total number of characters by the total number of words in the corpus. The empirical analysis may help identify noisy entries, such as job titles that significantly deviate from the expected word length. For example, if the average word length for job titles in a given language is five words, entries with unusually short or long titles may be flagged and excluded. The mean word length parameter ensures that the training data remains consistent and relevant to domain-specific translations.

At step 540, the target-to-source ratio parameter may be determined based on the performance of the machine translation model (e.g., as determined by process 400). For example, the target-to-source ratio parameter may be calculated by comparing the length of the translated text to the source text. According to some aspects, the target-to-source ratio may be determined by dividing the character or token count of the target (e.g., translated) text by the source text's length. A baseline ratio may be established for each language pair through linguistic research or previous translations. Deviations from the baseline, such as excessively long or short translations, may indicate errors. For example, a disproportionate increase in length when translating from English to German might signal a mistranslation. Moreover, the target-to-source ratio may be used to maintain proportionality and accuracy relative to the original text.

At step 550, the dropout rate parameter may be determined based on the performance of the machine translation model (e.g., as determined by process 400). For example, the dropout rate parameter may be determined through iterative testing during training. The dropout rate may refer to the percentage of neurons that are randomly deactivated during each iteration to prevent overfitting. An initial dropout rate may be selected (e.g., around 0.5), and may be adjusted based on performance on validation data. If overfitting is detected (e.g., evidenced by the machine translation model performing significantly better on training data than on validation data), the dropout rate may be increased. Conversely, if underfitting occurs, where the machine translation model fails to capture underlying patterns, the dropout rate may be reduced. This iterative adjustment may help the machine translation model generalize across unseen data.

At step 560, the cultural and gender-specific normalization parameter may be determined based on the performance of the machine translation model (e.g., as determined by process 400). For example, the cultural and gender-specific normalization parameter may be calculated by analyzing linguistic characteristics specific to culture and gender. Gendered terms in languages like French or Spanish may be detected using predefined dictionaries or linguistic rules. The normalization process may apply culturally appropriate alternatives, such as gender-neutral terms or region-specific vocabulary, to ensure that translations are both accurate and respectful.

At step 570, the noise filtering and data quality control parameter may be determined based on the performance of the machine translation model (e.g., as determined by process 400). For example, the noise filtering and data quality control parameter may be determined by calculating thresholds to identify and remove anomalous data points. Statistical analysis of the training data may be performed, computing metrics such as the mean and standard deviation for job title lengths, punctuation patterns, and term frequencies. Data entries that fall outside of a predefined range, such as two standard deviations from the mean, may be flagged as noise. The noisy entries may be removed or corrected, ensuring that only high-quality data is used to train the model. This filtering process may improve the overall performance and reliability of the machine translation model.

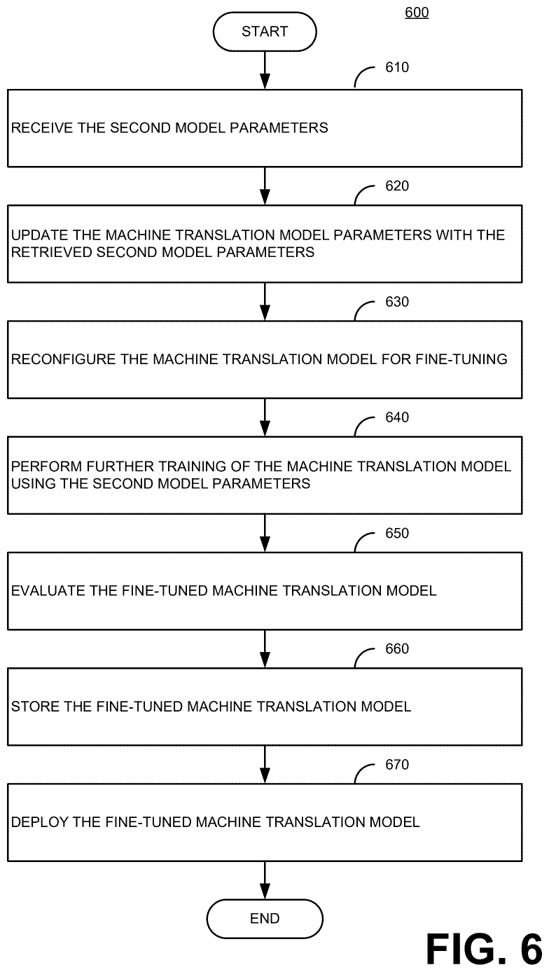

As illustrated in FIG. 6, process 600 may fine-tune the machine translation model. The process 600 may integrate the second model parameters into the machine translation model to enhance translation accuracy, domain specificity, and/or cultural fit, particularly for labor market data (e.g., job titles, skills, occupations, etc.). For example, the process 600 may incorporate second model parameters determined by process 500 into the machine learning model to improve the performance of the machine learning model relative to the first model parameters determined by process 300, as evidenced by the evaluation results from process 400.

At Step 610, the process 600 may receive the second model parameters (e.g., determined based on the performance evaluations from process 400). The second model parameters may include one or more adjustments to factors such as learning rate, batch size, target-to-source ratio, mean word length, and other hyperparameters that were fine-tuned during process 500.

At step 620, the process 600 may update the machine translation model parameters with the retrieved second model parameters. For example, the machine translation model's internal architecture may be modified, weights may be updated, and/or hyperparameters may be adjusted to reflect the optimized settings. For example, if the evaluation from process 400 indicated that the initial model was overfitting, the dropout rate may be increased to regularize the machine translation model and improve generalization. Similarly, cultural and gender-specific normalization parameters may be incorporated to ensure that the model produces culturally appropriate translations.

At step 630, the process 600 may reconfigure the machine translation model for fine-tuning. After updating the model parameters, the machine translation model may be reconfigured for a fine-tuning process. For example, the training environment may be prepared by preparing the tokenizer and loading the fine-tuning dataset, including domain-specific labor market data, job titles, and/or industry-specific phrases.

At step 640, the process 600 may perform further training of the machine translation model using the second model parameters. For example, the capabilities of the machine translation model may be honed to address cultural nuances and domain-specific terminology that were not fully captured in the initial training phase.

At step 650, the process 600 may evaluate the fine-tuned machine translation model. The machine translation model may be evaluated using a validation set, similar to the process in step 620. The evaluation may include human feedback from linguists, automated assessments using LLMs (e.g., GPT-4o), and/or checks for alignment with occupational taxonomies. For example, the process 600 may test whether job titles such as “Data Scientist” or “Software Developer” are translated correctly across languages, maintaining consistency in meaning and cultural fit.

At step 660, the process 600 may store the fine-tuned machine translation model. Once the performance of the machine translation model meets predefined thresholds, the fine-tuned machine translation model may be saved for deployment. The machine translation model may be optimized for real-time applications, ensuring that the machine translation model may efficiently process large volumes of labor market data across multiple languages.

At step 670, the process 600 may deploy the fine-tuned machine translation model. For example, the fine-tuned machine translation model may be deployed in production environments, where it may be used to translate job titles and other labor market data. The translated outputs may be transmitted to APIs for classification into occupation taxonomies associated with job search platforms and labor market analytics.

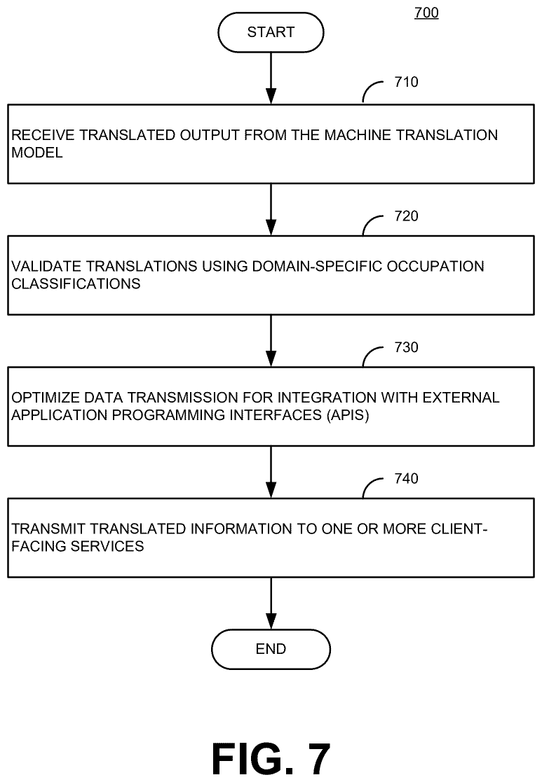

As illustrated in FIG. 7, a process 700 may transmit translated information generated by a fine-tuned multilingual machine translation model. The process 700 may address challenges associated with transmitting domain-specific translations, such as labor market data (e.g., job titles, skills, occupations, etc.), across different languages and regions.

At step 710, the process 700 may receive translated output from the machine translation model. This machine translation model may have been optimized to handle domain-specific terminologies, such as job titles and industry-specific phrases, across multiple languages. The machine translation model may use a deep learning-based architecture, incorporating language-specific parameters like the mean word length and the target-to-source ratio, which may be determined empirically for each language. For example, a German job title such as “Cloud Engineer” may be translated accurately by recognizing that the term “cloud” refers to cloud computing rather than the literal interpretation of “clouds” in the sky.

At step 720, the process 700 may validate translations using domain-specific occupation classifications. For example, the translated job titles and phrases may be validated against an occupation taxonomy. The process 700 may use the translated English titles as input to an occupation classifier, which may categorize the job titles into corresponding occupations within the taxonomy. For example, the translated title “Sales Engineer” may be mapped to its appropriate occupation in the taxonomy, ensuring that the translation is contextually aligned with industry standards. Thereby step 720 may enable the process 700 to validate that the translations are both accurate and meaningful within the context of labor market data (e.g., job titles, skills, occupations, etc.).

At step 730, the process 700 may optimize data transmission for integration with external APIs. The process 700 may optimize the translated information for transmission to external systems, such as one or more APIs. The process 700 may format the translated data according to the specifications of the external systems, ensuring that payload sizes and data formats are properly managed for efficient transmission. For example, if the translated job title is being transmitted to a job search platform, the process 700 may ensure that the data is classified correctly and ready for integration into the platform's occupation taxonomy. Thereby step 720 may streamline the real-time processing and classification of translated labor market data across different languages and regions.

At step 740, the process 700 may transmit translated information to one or more client-facing services. For example, the validated and optimized translated information may be transmitted to client-facing services, including job search platforms, labor market analytics tools, or other systems that rely on accurate and culturally appropriate translations. The translated data may be used for classifying job titles into occupation taxonomies, matching candidates with job postings, or providing insights into labor market trends. For example, the process 700 may transmit a translated job title like “Data Scientist” to an API that classifies it into an appropriate occupation category within a global taxonomy, ensuring consistency across different languages.

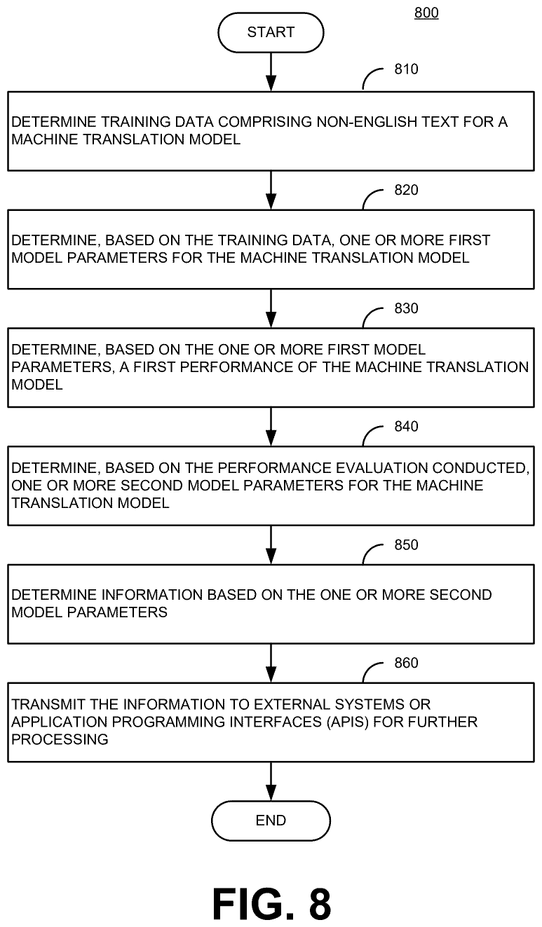

Referring now to FIG. 8, illustrated is a flowchart of a process 800, according to an aspect of the disclosed systems and processes. The process 800 may demonstrate a method for fine-tuning multilingual machine translation models to improve the accuracy and relevance of translations, particularly in specialized domains such as labor market data. Moreover, the process 800 may determine training data, adjust model parameters based on performance evaluations, and optimize the translation output for specific applications such as job titles and skill classifications across different languages.

At step 810, the process 800 may determine training data comprising non-English text for a machine translation model. For example, the process 800 may collect raw non-English text data from a variety of sources, such as job postings, labor market reports, and/or proprietary datasets. Moreover, the training data may originate from multiple languages and regions, including focusing on domain-specific content such as labor market data. The non-English text may be used to train the machine translation model to handle specialized terminologies and/or industry-specific phrases. Language-specific parameters, such as mean word length and target-to-source ratio, may be applied to the training data to filter out noisy or irrelevant data. For example, titles or phrases that deviate significantly from the expected length may be flagged for exclusion to maintain the integrity of the training data.

To further enhance the quality of the training data, the process 800 may include an adaptive text cleaning pipeline. The adaptive text cleaning pipeline may remove emojis, non-alphanumeric sequences, and/or other irrelevant content to improve the overall quality of the training data. By leveraging these preprocessing techniques, the process 800 may ensure that only high-quality, domain-specific content is used to fine-tune the machine translation model. The end result may be a refined dataset that enhances the ability of the machine translation model ability to handle complex linguistic patterns across multiple languages.

At step 820, the process 800 may determine, based on the training data collected in step 810, one or more first model parameters for the machine translation model. The one or more first model parameters may include hyperparameters, such as learning rate, batch size, dropout rate, and/or language-specific settings like mean word length. The one or more first model parameters may be used to optimize the training process and ensure that the machine translation model converges toward an accurate solution. For example, the learning rate may be dynamically adjusted based on performance metrics during training, allowing the machine translation model to make rapid improvements in the early stages while fine-tuning adjustments during later iterations to avoid overfitting.

According to some aspects, the one or more first model parameters may include language-specific adjustments to account for variations in grammar, word length, and cultural context. For example, the process 800 may adjust the target-to-source ratio to ensure proportionality between the source text and the translated output, preventing mistranslations that result in overly long or short translations. Additionally, gender-specific terms in languages such as French or Spanish may be normalized to provide culturally appropriate translations. These adjustments may ensure that the machine translation model is finely tuned to handle the nuances of each language.

At step 830, the process 800 may determine, based on the one or more first model parameters determined in step 820, a first performance of the machine translation model. Evaluation of the first performance may include testing the machine translation model on a validation dataset comprising domain-specific content, such as job titles, skills, or industry-specific terminologies. The process 800 may employ one or more of human linguistic feedback and/or automated large language model (LLM) evaluations, such as GPT-4o, to assess translation accuracy, cultural fit, and terminology appropriateness. For example, human reviewers may provide feedback on whether the translated job titles maintain their meaning and relevance within a specific labor market context.

Automated evaluation techniques, such as using LLMs, may further streamline the performance evaluation by providing real-time feedback on the alignment between the predicted translations and the intended classifications. The process 800 may compare the translated job titles against occupational taxonomies, identifying potential issues where translations fail to match the target classification. The evaluations may provide a robust mechanism for assessing the ability of the machine translation model to deliver high-quality, contextually relevant translations.

At step 840, the process 800 may determine, based on the performance evaluation conducted in step 830, one or more second model parameters for the machine translation model. The one or more second model parameters may include refinements to the hyperparameters, such as reducing the learning rate to fine-tune the model or adjusting the dropout rate to prevent overfitting. Moreover, the process 800 may modify language-specific parameters, such as target-to-source ratio or mean word length, to correct any inconsistencies identified during the evaluation phase. For example, if the process 800 detects that certain translations are too literal or culturally inappropriate, it may adjust the machine translation model to produce more contextually relevant translations.

According to some aspects, feedback may be incorporate from domain experts and linguistic teams, who may provide corrections or adjustments to the training data. For example, if a literal translation is flagged as incorrect, the process 800 may retrain the machine translation model with revised data and parameters. This iterative process of fine-tuning the machine translation model may ensure continuous improvement in translation quality, particularly for domain-specific contexts such as labor market data.

At step 850, the process 800 may determine information based on the one or more second model parameters determined in step 840. The translated information (e.g., translations) may include job titles, skill classifications, or other labor market data, which may be tailored to the specific requirements of the target language and industry. By incorporating the refinements made during the fine-tuning process, the process 800 may produce highly accurate and contextually appropriate translations. For example, the process 800 may ensure that job titles such as “Cloud Engineer” are translated in a way that reflects their true meaning within the context of information technology, rather than producing literal translations that are culturally irrelevant.

The information determined in step 840 may also include metadata, such as language-specific features or cultural adjustments, which may provide additional context for the translated data. For example, the process 800 may indicate whether gender-specific terms have been normalized or whether any cultural nuances have been accounted for in the translation. The metadata may enhance the usability of the translated information, particularly for downstream applications such as classification into occupational taxonomies.

At step 860, the process 800 may transmit the information to external systems or APIs for further processing. For example, the translated job titles may be transmitted to a classification API that organizes them into an occupation taxonomy associated with a job search platform. Moreover, the translated data may be integrated into client-facing systems in real-time, allowing businesses to automate their multilingual operations across different languages and regions.

The process 800 may leverage techniques such as load balancing and multi-threading to handle large volumes of translation requests efficiently and optimize data transmission. Moreover, error-handling mechanisms may be implemented to address potential issues, such as API failures or discrepancies between the source and target languages during classification. By ensuring that the information is transmitted reliably and efficiently, the process 800 may provide a scalable solution for global applications.

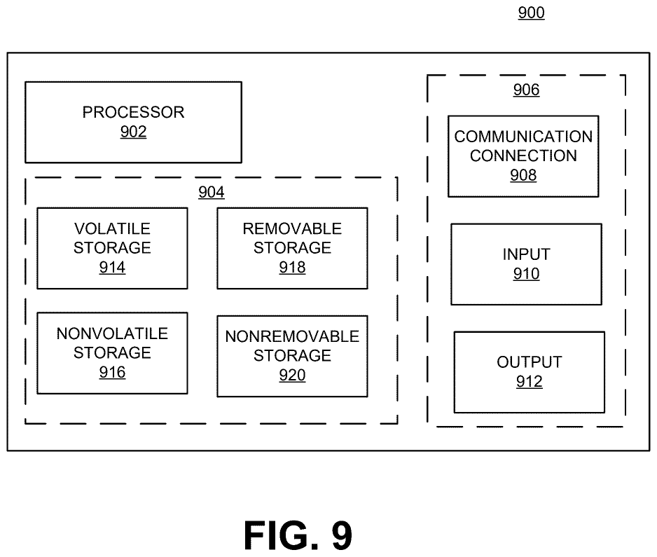

FIG. 9 is a block diagram of a computing device 900 that may be connected to or comprise a component of system 102. Computing device 900 may comprise hardware or a combination of hardware and software. The functionality to facilitate fine-tuning multilingual machine translation models may reside in one or a combination of computing devices 900. Computing device 900 depicted in FIG. 9 may represent or perform functionality of an appropriate computing device 900, or a combination of computing devices 900, such as, for example, a component or various components of an machine translation model fine tuning system, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 9 is an example and is not intended to imply a limitation to a specific example or configuration. Thus, computing device 900 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 900 may comprise a processor 902 and a memory 904 coupled to processor 902. The memory 904 may contain executable instructions that, when executed by the processor 902, may cause the processor 902 to effectuate operations associated with fine-tuning multilingual machine translation models. As evident from the description herein, the computing device 900 is not to be construed as software per se.

In addition to a processor 902 and memory 904, a computing device 900 may include an input/output system 906. The processor 902, memory 904, and input/output system 906 may be coupled together (coupling not shown in FIG. 9) to allow communications between them. Each portion of the computing device 900 may comprise circuitry for performing functions associated with each respective portion. Thus, each portion may comprise hardware, or a combination of hardware and software. Accordingly, each portion of a computing device 900 is not to be construed as software per se. An input/output system 906 may be capable of receiving or providing information from or to a communications device or other network entities configured for fine-tuning multilingual machine translation models. For example, the input/output system 906 may include a wireless communication (e.g., 3G/4G/5G/GPS) card. The input/output system 906 may be capable of receiving or sending video information, audio information, control information, image information, data, or any combination thereof. Input/output system 906 may be capable of transferring information with the computing device 900. In various configurations, the input/output system 906 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 906 may comprise a Wi-Fi finder, a two-way GPS chipset or equivalent, or the like, or a combination thereof.

Embodiments of the input/output system 906 of a computing device 900 also may contain a communication connection 908 that allows the computing device 900 to communicate with other devices, network entities, or the like. The communication connection 908 may comprise communication media. Communication media may typically embody computer-readable instructions, data structures, program modules or other data in a modulated data signal such as a carrier wave or other transport mechanism and may include any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 906 also may include an input device 910 such as keyboard, mouse, pen, voice input device, or touch input device. The input/output system 906 may also include an output device 912, such as a display, speakers, or a printer.

Embodiments of the processor 902 may be capable of performing functions associated with fine-tuning multilingual machine translation models, as described herein. For example, a processor 902 may be capable of, in conjunction with any other portion of the computing device 900, fine-tuning multilingual machine translation models, as described herein.

Embodiments of a memory 904 of the computing device 900 may comprise a storage medium having a concrete, tangible, physical structure. As is known, a signal does not have a concrete, tangible, physical structure. The memory 904, as well as any computer-readable storage medium described herein, is not to be construed as a signal. The memory 904, as well as any computer-readable storage medium described herein, is not to be construed as a transient signal. The memory 904, as well as any computer-readable storage medium described herein, is not to be construed as a propagating signal. The memory 904, as well as any computer-readable storage medium described herein, is to be construed as an article of manufacture.

The memory 904 may store any information utilized in conjunction with fine-tuning multilingual machine translation models. Depending upon the exact configuration or type of processor, a memory 904 may include a volatile storage 914 (such as some types of RAM), a nonvolatile storage 916 (such as ROM, flash memory), or a combination thereof. The memory 904 may include additional storage (e.g., a removable storage 918 or a non-removable storage 920) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 900. The memory 904 may comprise executable instructions that, when executed by a processor 902, cause the processor 902 to effectuate operations associated with fine-tuning multilingual machine translation models.

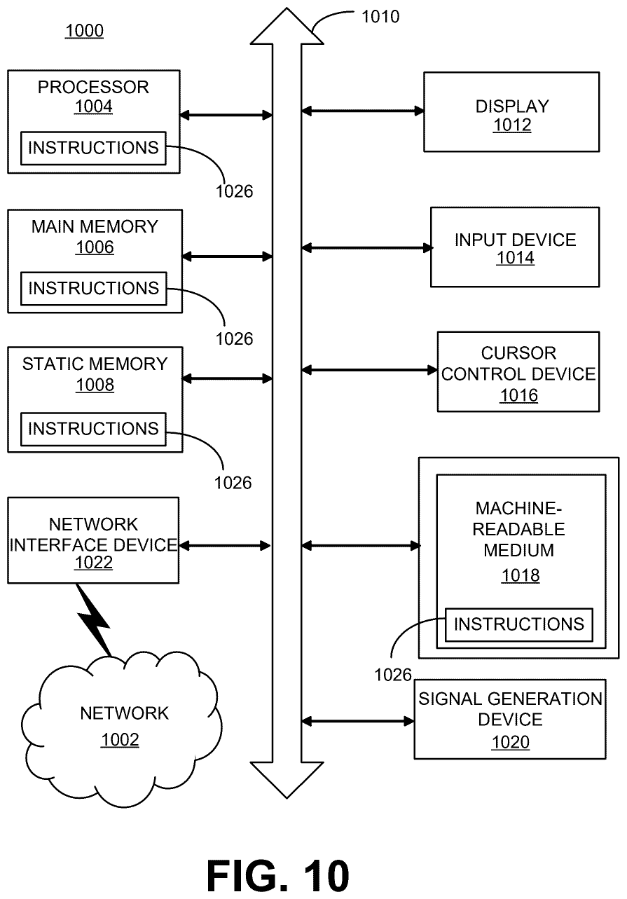

FIG. 10 depicts an example of a diagrammatic representation of a machine in the form of a computer system 1000 within which a set of instructions, when executed, may cause the machine to perform any one or more of the methods described above. One or more instances of the machine can operate, for example, as computing devices 104, system 102, server 108, database 110, processor 1004, and other devices of FIGS. 1-10. In some examples, the machine may be connected (e.g., using a network 1002) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

A computer system 1000 may include a processor (or controller) 1004 (e.g., a central processing unit (CPU)), a graphics processing unit (GPU, or both), a main memory 1006 and a static memory 1008, which communicate with each other via a bus 1010. The computer system 1000 may further include a display unit 1012 (e.g., a liquid crystal display (LCD), a flat panel, or a solid-state display). The computer system 1000 may include an input device 1014 (e.g., a keyboard), a cursor control device 1016 (e.g., a mouse), a disk drive unit 1018, a signal generation device 1020 (e.g., a speaker or remote control) and a network interface device 1022. In distributed environments, the examples described in the subject disclosure can be adapted to utilize multiple display units 1012 controlled by two or more computer systems 1000. In this configuration, presentations described by the subject disclosure may in part be shown in a first of display units 1012, while the remaining portion is presented in a second of display units 1012.

The disk drive unit 1018 may include a tangible computer-readable storage medium on which is stored one or more sets of instructions (e.g., instructions 1026) embodying any one or more of the methods or functions described herein, including those methods illustrated above. Instructions 1026 may also reside, completely or at least partially, within the main memory 1006, the static memory 1008, or within the processor 1004 during execution thereof by the computer system 1000. The main memory 1006 and the processor 1004 also may constitute tangible computer-readable storage media.

While examples of a system for fine-tuning multilingual machine translation models have been described in connection with various computing devices/processors, the underlying concepts may be applied to any computing device, processor, or system capable of fine-tuning multilingual machine translation models. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for fine-tuning multilingual machine translation models. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with fine-tuning multilingual machine translation models as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for fine-tuning multilingual machine translation models as described herein. When implemented on a general-purpose processor, the program code combines with the processor to provide a unique device that operates to invoke the functionality of a multilingual machine translation model fine-tuning system.

While the disclosed systems have been described in connection with the various examples of the various figures, it is to be understood that other similar implementations may be used, or modifications and additions may be made to the described examples of a multilingual machine translation model fine-tuning system without deviating therefrom. For example, one skilled in the art will recognize that a multilingual machine translation model fine-tuning system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—fine-tuning multilingual machine translation models—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
determine training data comprising text of one or more languages for a machine translation model;
determine, based on the training data, one or more first model parameters for the machine translation model;
determine, based on the one or more first model parameters, a first performance of the machine translation model;
determine, based on the first performance, one or more second model parameters for the machine translation model;
determine, based on the one or more second model parameters, information; and
transmit the information.

2. The one or more computing devices of claim 1, wherein determining the training data comprises applying a plurality of language-specific training parameters comprising a mean word length and a target-to-source ratio.

3. The one or more computing devices of claim 1, further configured to detect variations in the training data comprising inconsistent capitalization and punctuation, wherein the first model parameters are determined based on the variations in the training data.

4. The one or more computing devices of claim 1, wherein the one or more first model parameters are associated with gender normalization or cultural translation adjustments.

5. The one or more computing devices of claim 1, wherein the one or more first model parameters are determined based on a plurality of hyperparameters.

6. The one or more computing devices of claim 1, wherein the first performance is determined by testing the machine translation model with a validation dataset.

7. The one or more computing devices of claim 1, wherein the machine translation model comprises cultural or gender normalization parameters.

8. The one or more computing devices of claim 1, further configured to determine a translation accuracy associated with the machine translation model, wherein the first performance is determined based on the translation accuracy.

9. The one or more computing devices of claim 1, further configured to determine a cultural fit associated with the machine translation model, wherein the first performance is determined based on the cultural fit.

10. The one or more computing devices of claim 1, further configured to determine, based on the one or more second model parameters, a second performance, wherein the second performance exceeds the first performance.

11. The one or more computing devices of claim 1, wherein the training data comprises labor market data.

12. The one or more computing devices of claim 1, wherein determining the one or more second model parameters comprises optimizing the first performance using multi-core processing to enhance graphics processing unit (GPU) utilization.

13. The one or more computing devices of claim 1, wherein the first performance of the machine translation model is determined based on an evaluation associated with a large language model (LLM).

14. The one or more computing devices of claim 1, wherein the second model parameters are determined based on translation accuracy, cultural fit, and terminology appropriateness in labor market data.

15. The one or more computing devices of claim 1, wherein the training data is determined based on an adaptive text cleaning pipeline comprising at least one of emoji removal, non-alphanumeric sequence handling, or rule-based language-specific post-processing.

16. The one or more computing devices of claim 1, wherein the information comprises translated labor market data.

17. The one or more computing devices of claim 1, wherein determining the second model parameters comprises generalizing translations by a deep learning model.

18. The one or more computing devices of claim 1, wherein the information is transmitted to one or more data pipelines or an application programming interface (API) associated with integration into a client-facing service that classifies job titles into corresponding occupations based on a global taxonomy.

19. A method performed by one or more computing devices, the method comprising:
determining training data comprising text of one or more languages for a machine translation model;
determining, based on the training data, one or more first model parameters for the machine translation model;
determining, based on the one or more first model parameters, a performance of the machine translation model;
determining, based on the performance, one or more second model parameters for the machine translation model;
determining, based on the one or more second model parameters, information; and
transmit the information.

20. A system comprising:
one or more processors; and
a memory coupled with the one or more processors, the memory storing executable instructions that when executed by the one or more processors cause the one or more processors to effectuate operations comprising:
determining training data for a machine translation model;
determining, based on the training data, one or more first model parameters for the machine translation model;
determining, based on the one or more first model parameters, a performance of the machine translation model;
determining, based on the performance, one or more second model parameters for the machine translation model;
determining, based on the one or more second model parameters, information; and
transmit the information.
